(19) United States
(12) Patent Application Publication
(10) Pub. No.: US 2007/0296682 A1
(43) Pub. Date: Dec. 27, 2007

(54) LIQUID CRYSTAL DISPLAY DEVICE AND DRIVING METHOD THEREOF

(75) Inventor: In Jae Hwang, Cheonan-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/764,893

(22) Filed: Jun. 19, 2007

(30) Foreign Application Priority Data
Jun. 22, 2006 (KR) 10-2006-0056230

(51) Int. Cl. G09G 3/36

(52) U.S. Cl. 345/100

(57) ABSTRACT

A liquid crystal display (“LCD”) device capable of improving a response speed of liquid crystals includes an LCD panel for displaying images and first and second gate driving circuits connected respectively to opposite sides of each of a plurality of gate lines formed in the LCD panel, driving the plurality of gate lines. When the first gate driving circuit supplies a gate ON voltage to the N^{th} gate line, where N is a natural number, the second gate driving circuit supplies a precharge voltage to the (N+4n)^{th} gate line, where n is a natural number.

This application claims priority to Korean Patent Application No. 2006-56230, filed on June 22, 2006 and all the benefits accruing therefrom under 35 U.S.C. § 119, and the contents of which in its entirety are herein incorporated by reference.

### BACKGROUND OF THE INVENTION

1. Field of the Invention

The present invention relates to a liquid crystal display (“LCD”) device and a driving method thereof, more particularly, to an LCD device and driving method capable of improving a response time of liquid crystals.

2. Description of the Related Art

A liquid crystal display (“LCD”) device displays images by using the electro-optical characteristics of liquid crystals. Particularly, the LCD device includes an LCD panel displaying images through a pixel matrix, and a driving circuit driving the LCD panel. Since the LCD panel does not emit light by itself, the LCD device further includes a backlight unit supplying light from the back of the LCD panel. The LCD panel controls the transmittance of the light supplied from the backlight unit by varying an arrangement state of liquid crystals in each subpixel responding to a video signal, thereby displaying images. The LCD device is widely used ranging from a small-sized display device to a large-sized one, such as a mobile telecommunication terminal, a notebook computer, an LCD television, etc.

The LCD device may use an inversion driving method in which the polarity of a voltage charged to a subpixel is periodically inverted in order to prevent the liquid crystals from degrading and to improve display quality. The inversion driving method mainly uses a vertical n-dot inversion method in which the polarity of a voltage charged to a subpixel is inverted on a dot basis in the horizontal direction and on an n-dot basis in the vertical direction. A response speed of the liquid crystals in a twisted nematic (“TN”) liquid crystals mode is slow when an image varies from black to white or from white to black. Namely, when a voltage applied to a corresponding subpixel is higher or lower than a reference value, luminance varies to two steps as shown by portion “A” in FIG. 1, thereby a response speed is slow.

FIG. 2 illustrates waveforms of a data driving signal and a gate driving signal applied to a pixel when an image varies from black to white.

As shown in FIG. 2, when considering only 1/60 seconds after the image varies from black, if it is assumed that a white voltage and a capacitance applied to a pixel while the first white frame starts are V′ and C′, respectively, and a white voltage and a capacitance applied to the pixel immediately before the second white frame is applied are V″ and C″, respectively, an electric charge in the same frame is expressed by the following equation (1) according to electric charge conservation law:

$${C}^{′} {V}^{′} = {C}^{″} {V}^{″} \\ {V}^{″} = \frac{{C}^{′}}{{C}^{″}} {V}^{′} = \frac{{C}_{st} + ɛ ( {V}^{′} ) {ɛ}_{0} A / d}{{C}_{st} + ɛ ( {V}^{″} ) {ɛ}_{0} A / d} \qquad ( 1 )$$

where ε(V′) is a dielectric constant of a liquid crystal maintaining state in black, and ε(V″) is a dielectric constant of a liquid crystal changed to white state.

In Equation (1), when the image is changed to white from black, the white voltage is raised by a variation of the liquid crystal capacitance and the raised white voltage is actually applied to the pixel. An increase of the white voltage leads to a decrease of the white luminance in the first frame and a voltage to be actually applied is supplied in the next frame, thereby generating a cusp phenomenon in an actual response waveform. The cusp phenomenon delays a response speed of the liquid crystals and brings out a display defect.

The response speed is defined as a time to change a difference in luminance between two gray levels from 10% to 90%, as shown in FIG. 1. To reduce the influence of the cusp, the influence of a capacitance value of the previous gray level should be minimized during a variation of a gray level. A storage capacitance should be maintained great enough to reduce the cusp phenomenon. However, when the storage capacitance is increased, an area occupied by a storage electrode is increased and thus an aperture ratio is reduced.

### BRIEF SUMMARY OF THE INVENTION

The present invention obviates the above problems and an exemplary embodiment of the present invention provides an LCD device and a driving method thereof, capable of improving a response time of liquid crystals.

More particularly, exemplary embodiments of the present invention provide an LCD device and a driving method thereof, which can improve a response speed by supplying a precharge voltage to the (N+4n)^{th} (where N and n are natural numbers) gate line of an LCD panel by first and second gate driving circuits, when a gate ON voltage is supplied to the N^{th} gate line.

In one aspect of the present invention, there is provided an LCD device, including an LCD panel displaying images, and first and second gate driving circuits connected to first and second sides of each of a plurality of gate lines formed in the LCD panel, driving the plurality of gate lines respectively, wherein when the first gate driving circuit supplies a gate ON voltage to an N^{th} gate line, where N is a natural number, the second gate driving circuit supplies a gate precharge voltage to an (N+4n)^{th} gate line, where n is a natural number.

The first and second gate driving circuits may be integrated in the LCD panel.

The LCD device may further include a first level shifter generating a first clock signal, a first inverted clock signal, and a first start pulse and supplying to the first gate driving circuit a first clock signal, a first inverted clock signal, and a first start pulse. The LCD device may further include a second level shifter generating a second clock signal, a second inverted clock signal, and a second start pulse and supplying to the second gate driving circuit a second clock signal, a second inverted clock signal, and a second start pulse.

The LCD device may further include a power source supplying the gate ON voltage and a gate OFF voltage to the first and second level shifters and a timing controller for supplying to the first level shifter a first gate start pulse selecting a first gate line, a gate shift clock selecting a next gate line, and a first output control signal controlling an output of the first clock signal, and supplying to the second level shifter a second gate start pulse selecting the first gate line, the gate shift clock selecting the next gate line, and a second output control signal controlling an output of the second clock signal.

The first level shifter may include a logic circuit generating a clock by an OR operation of the gate shift clock and the first output control signal and the second level shifter may include a logic circuit generating a clock by an OR operation of the gate shift clock and the second output control signal.

The LCD device may further include a data driving circuit driving data lines formed in the LCD panel, a data tape carrier package in which the data driving circuit is mounted, and a data printed circuit board in which the power source, the timing controller, and the first and second level shifters are mounted, the data printed circuit board being connected to the data tape carrier package.

A supply time of a high level of the second output control signal may be the same as or shorter than a supply time of a high level of the first output control signal.

The first gate driving circuit may include a first shift register generating the first clock signal as the gate ON voltage and generating the first inverted clock signal as the gate OFF voltage and the second gate driving circuit may include a second shift register generating the second clock signal as the precharge voltage and generating the second inverted clock signal as the gate OFF voltage.

A supply time of the precharge voltage may be the same as or shorter than a supply time of the gate ON voltage.

The first and second gate driving circuits may be mounted in the LCD panel in a chip-on-glass form.

The LCD device may further include first and second gate tape carrier packages connected to the LCD panel, respectively mounting the first and second gate driving circuits therein, and the first and second gate printed circuit boards connected respectively to the first and second gate tape carrier packages, supplying signals to the first and second gate driving circuits.

The LCD panel may be driven by a vertical n-dot inversion method, where n is a natural number, in which a polarity of a subpixel is inverted on an n-dot basis in a vertical direction and inverted on one dot basis in a horizontal direction.

In another aspect of the present invention, there is provided a method of driving an LCD device, the method including supplying a gate ON voltage to an N^{th} gate line, where N is a natural number, by a first gate driving circuit and supplying a precharge voltage to an (N+4n)^{th} gate line, where n is a natural number, by a second gate driving circuit while the gate ON voltage is supplied to the N^{th} gate line.

The method may further include generating a first clock signal, a first inverted clock signal, and a first start pulse by a first level shifter and supplying the first clock signal, the first inverted clock signal, and the first start pulse to the first gate driving circuit, and generating a second clock signal, a second inverted clock signal, and a second start pulse by a second level shifter and supplying the second clock signal, the second inverted clock signal, and the second start pulse to the second gate driving circuit.

The method may further include supplying a first gate start signal, a gate shift clock, and a first output control signal to the first level shifter and supplying a second gate start signal, the gate shift clock, and a second output control signal to the second level shifter by a timing controller, and supplying gate ON and OFF voltages to the first and second level shifters by a power source.

The method may further include generating the first clock signal by an OR operation of the gate shift clock and the first output control signal and generating the first inverted clock signal that is an inverted signal of the first clock signal by the first level shifter, and supplying the first clock signal and the first inverted clock signal to the first gate driving circuit, and generating the second clock signal by an OR operation of the gate shift clock and the second output control signal and generating the second inverted clock signal that is an inverted signal of the second clock signal by the second level shifter, and supplying the second clock signal and the second inverted clock signal to the second gate driving circuit.

The method may further include outputting the first clock signal as the gate ON voltage by the first gate driving circuit when the N^{th} gate line is driven, and supplying the second clock signal as the precharge voltage to the (N+4n)^{th} gate line by the second gate driving circuit.

A supply time of the precharge voltage to the (N+4n)^{th} gate line may be the same as or shorter than a supply time of the gate ON voltage to the N^{th} gate line.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a waveform chart illustrating the deterioration of a response speed generated during dot inversion driving in a conventional LCD device;

FIG. 2 is a waveform chart showing the exemplary data signal and gate signal applied to a pixel when a screen varies from black to white;

FIG. 3 is a block diagram schematically illustrating an exemplary embodiment of an LCD device in accordance with the present invention;

FIG. 4 is a plan view illustrating the exemplary LCD device shown in FIG. 3;

FIGS. 5A and 5B are views schematically illustrating the exemplary first and second level shifters shown in FIGS. 3 and 4;

FIGS. 6A and 6B are waveform charts illustrating input and output signals from the exemplary first and second level shifters shown in FIGS. 5A and 5B, respectively;

FIG. 7 is a block diagram schematically illustrating an exemplary internal configuration of each of the exemplary first and second gate driving circuits shown in FIGS. 3 and 4;

FIG. 8 is a waveform chart comparing the first and second clock signals generated from the exemplary first and second level shifters and the gate ON voltage and the precharge voltage supplied from the exemplary first and second gate driving circuits;

FIG. 9 is a plan view illustrating a first exemplary embodiment of a driving method of the exemplary LCD device by a vertical 2-dot inversion driving method in accordance with the present invention; and

FIG. 10 is a plan view schematically illustrating another exemplary embodiment of an LCD device in accordance with the present invention.

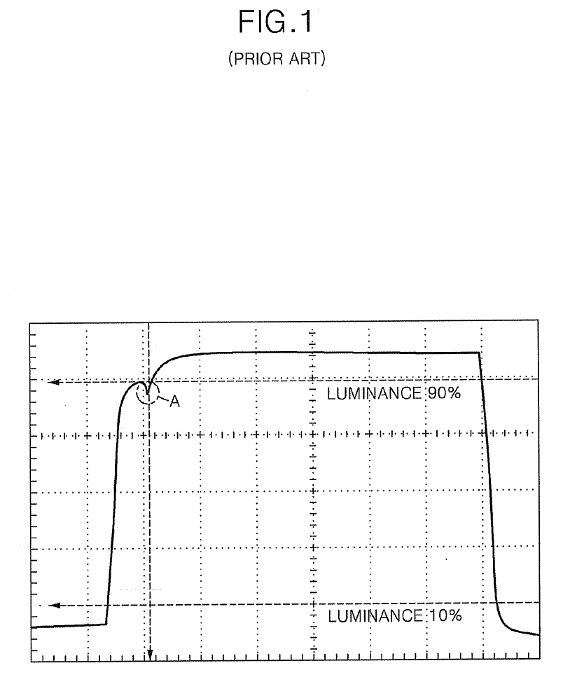

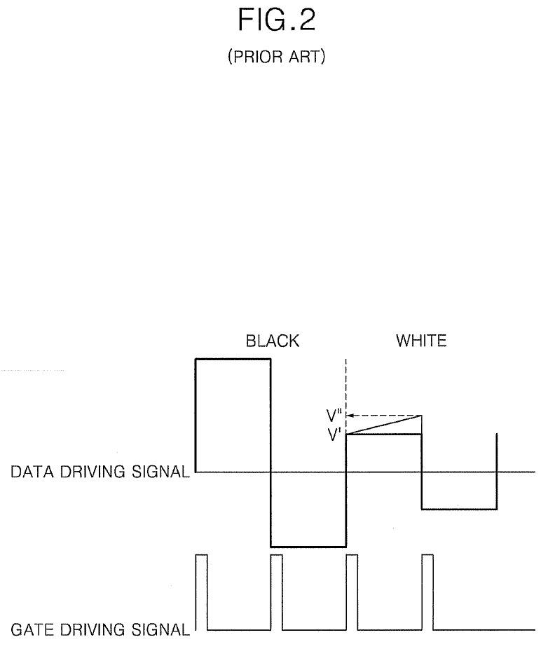

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, an exemplary embodiment of the present invention will be explained in detail with reference to the accompanying drawings.

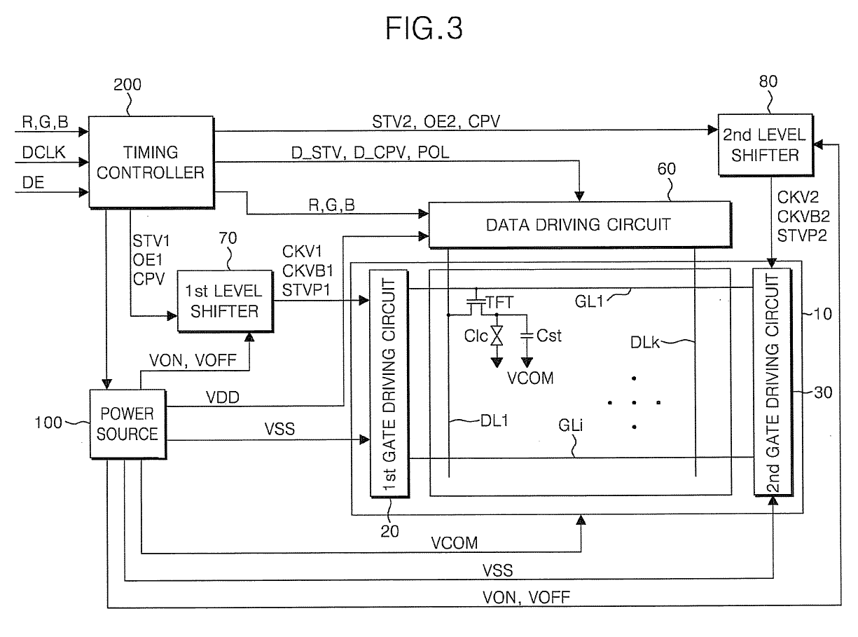

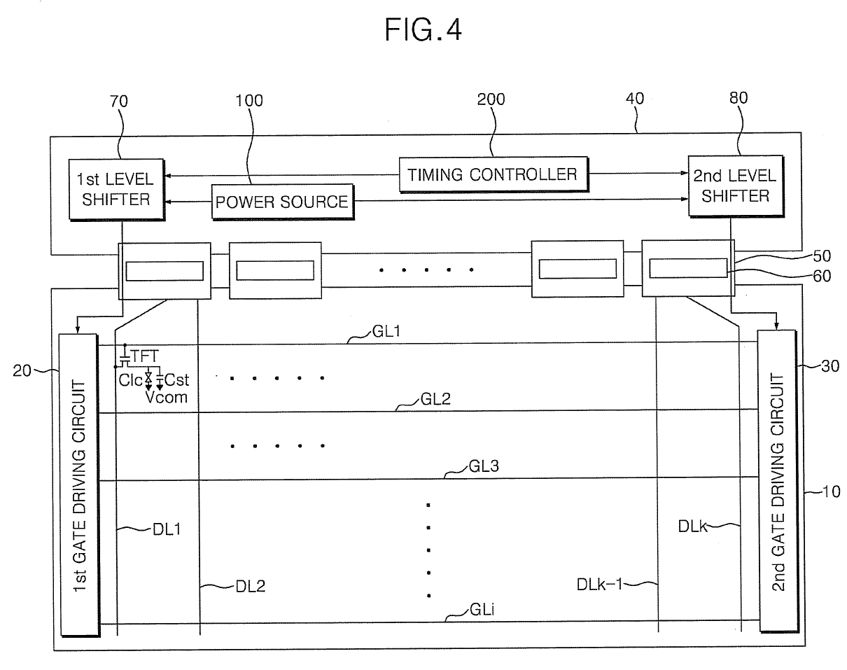

FIG. 3 is a block diagram schematically illustrating an exemplary embodiment of an LCD device in accordance with the present invention. FIG. 4 is a plan view illustrating the exemplary LCD device shown in FIG. 3.

Referring to FIGS. 3 and 4, the LCD device includes an LCD panel 10 in which a plurality of gate lines GL1 to GLi and a plurality of data lines DL1 to DLk are formed, and first and second gate driving circuits 20 and 30 connected respectively to opposite sides of each of the plurality of the gate lines GL1 to GLi, driving the plurality of gate lines GL1 to GLi. When a gate ON voltage VON is supplied to the nth (where n is a natural number) gate line GLN, a precharge voltage VF is supplied to the (N+4n)^{th} (where N is a natural number) gate line GLN+4n. The first and second gate driving circuits 20 and 30 are integrated onto a thin film transistor (“TFT”) substrate of the LCD panel 10. The LCD device also includes a first level shifter 70 and a second level shifter 80. The first level shifter 70 generates and supplies a first clock signal CKV1, a first inverted clock signal CKVB1, and a first start pulse STVP1 performing a driving command of the first gate line GL1 to the first gate driving circuit 20. The second level shifter 80 generates and supplies a second clock signal CKV2, a second inverted clock signal CKVB2, and a second start pulse STVP2 performing a precharging command of the fifth gate line to the second gate driving circuit 30. The LCD device also includes a data driver driving a plurality of data lines DL1 to DLk formed on the TFT substrate. The data driver includes a data printed circuit board (“PCB”) 40, a data tape carrier package (“TCP”) 50 connected to the data PCB 40, and a data driving circuit 60 mounted on the data TCP 50, supplying a data signal to the data lines DL1 to DLk. The LCD device also includes a timing controller 200 and a power source 100. The timing controller 200 generates control signals and image signals and supplies the control signals and the image signals to the data driving circuit 60. The power source 100 supplies power signals to the first and second level shifters 70 and 80, the timing controller 200, the first and second gate driving circuits 20 and 30, and the data driving circuit 60.

The LCD panel 10 includes the TFT substrate in which a TFT array is formed, a color filter substrate facing the TFT substrate in which a color filter array is formed, and liquid crystals disposed between the TFT substrate and the color filter substrate.

The color filter substrate includes a black matrix preventing light leakage, the color filter array displaying colors and a common electrode supplying a common voltage VCOM to the liquid crystals.

The liquid crystals are driven by a voltage difference between a pixel electrode to which the data signal is supplied and a common electrode to which the common voltage VCOM is supplied. Then the liquid crystals having dielectric anisotropy rotate according to the voltage difference and change the transmittance of light emitted from a light source. The liquid crystals use twisted nematic (“TN”)-mode or patterned vertical alignment (“PVA”)-mode liquid crystals.

The TFT substrate includes the gate lines GL1 to GLi, the data lines DL1 to DLk, pixel areas in which the gate lines GL1 to GLi intersect with the data lines DL1 to DLk, TFTs connected to the gate lines GL1 to GLi and data lines DL1 to DLk in the respective pixel areas, and pixel electrodes connected to the TFTs. The first and second gate driving circuits 20 and 30 driving the plurality of gate lines GL1 to GLi may be integrated onto the TFT substrate. In this case, the first and second gate driving circuits 20 and 30 are respectively formed at opposite sides of each of the plurality of gate lines GL1 to GLi formed on the TFT substrate, with the gate lines GL1 to GLi disposed there between, and their outputs are connected to the gate lines GL1 to GLi.

The power source 100 generates an analog driving voltage VDD, a common voltage VCOM, a gate ON voltage VON, and a gate OFF voltage VOFF by using an input driving voltage. The analog driving voltage VDD is supplied to the data driving circuit 60, the common voltage VCOM is supplied to the LCD panel 10, and the gate ON and OFF voltages VON and VOFF are supplied to the first and second level shifters 70 and 80. The power source 100 may also supply a DC voltage VSS to the first and second gate driving circuits 20 and 30.

The timing controller 200 arranges R, G, and B image data signals applied from the exterior and supplies the arranged data signals to the data driving circuit 60. The timing controller 200 generates a plurality of control signals for controlling the driving timing of the first and second level shifters 70 and 80 and the data driving circuit 60 by using a plurality of synchronizing signals, such as, a dot clock DCLK, a data enable signal DE, a vertical synchronizing signal VSYC, and a horizontal synchronizing signal HSYC, input from the exterior together with the R, G, B image data signals. For instance, the timing controller 200 generates and supplies control signals including gate start pulses STV1 and STV2, a gate shift clock CPV, and output control signals OE1 and OE2 to the first and second level shifters 70 and 80. In addition, the timing controller 200 generates and supplies data control signals including a data start pulse D_STV, a data shift clock D_CPV, and a polarity control signal POL to the data driving circuit 60.

The data driving circuit 60 converts digital data, such as the arranged data signals R, G, B, into an analog data signal in response to the control signals from the timing controller 200 and the analog driving voltage VDD from the power source 100, and supplies the analog data signal to the data lines DL1 to DLk whenever the gate ON voltage VON is supplied to the gate lines GL1 to GLi. The data driving circuit 60 includes a shift register, a latch, a digital-to-analog converter (“DAC”), and an output buffer. The shift register sequentially shifts the data start pulse D_STV generated from the timing controller 200 according to the data shift clock D_CPV and generates a sampling control signal. The latch sequentially latches data R, G, B input from the timing controller 200 in response to the sampling control signal, and supplies the latched data to the digital-analog converter when data corresponding to one horizontal line is latched. The digital-analog converter selects a gamma voltage corresponding to the data from the latch among a plurality of gamma voltages and converts the selected gamma voltage into an analog data signal. The output buffer buffers the data signal from the digital-analog converter and supplies the buffered data signal to the data line DL. The digital-to-analog converter selects a positive or negative polarity gamma voltage according to the polarity control signal POL from the timing controller 200 and converts the selected voltage into an analog data signal. Especially, the digital-to-analog converter supplies data signals having the opposite polarity to output channels adjacent to the right and left in response to the polarity control signal POL corresponding to a vertical dot inversion method, and inverts the polarity of the data signals supplied through the output channels on a horizontal period basis.

The data driving circuit 60 may be mounted on the data TCP 50 and connected to the data PCB 40, as shown in FIG. 4. The timing controller 200 and the power source 100 may be mounted on the data PCB 40. In such an embodiment, the image signals, control signals, and power signals generated from the timing controller 200 and the power source 100 are supplied to the data driving circuit 60 mounted on the data TCP 50 and to the LCD panel 10 via signal lines formed in the data TCP 50.

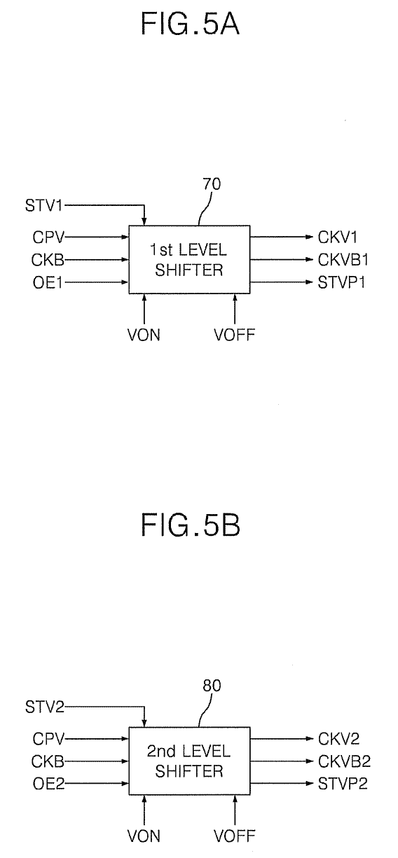

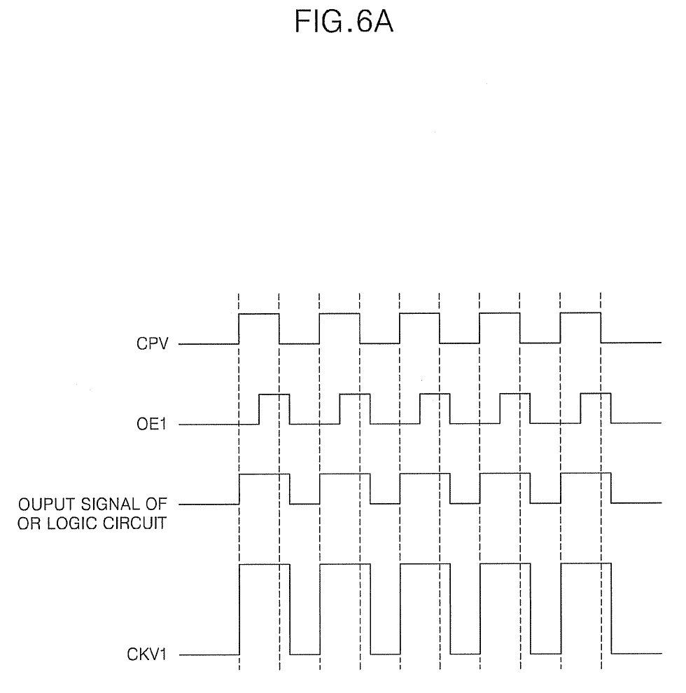

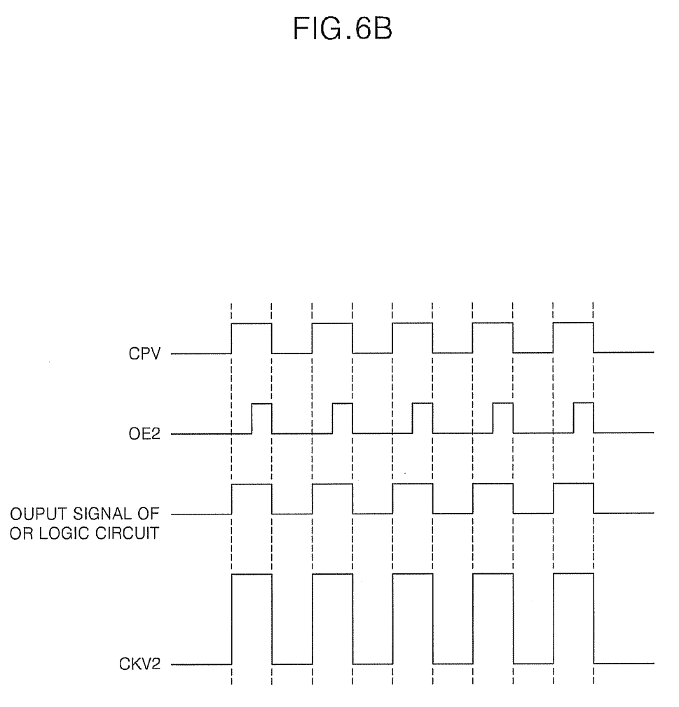

FIGS. 5A and 5B are views schematically illustrating the exemplary first and second level shifters, respectively, shown in FIGS. 3 and 4. FIGS. 6A and 6B are waveform charts illustrating input and output signals from the exemplary first and second level shifters shown in FIGS. 5A and 5B.

Referring to FIG. 5A, the first level shifter 70 generates and supplies the first clock signal CKV1, the first inverted clock signal CKVB1, and the first start pulse STVP1 to the first gate driving circuit 20. To this end, the first level shifter 70 generates the first clock signal CKV1 and the first inverted clock signal CKVB1 by using the gate shift clock CPV and a first output control signal OE1 generated from the timing controller 200. To generate the first clock signal CKV1, the first level shifter 70 further includes a logic circuit performing an OR operation. As shown in FIG. 6A, the first level shifter 70 generates a clock by an OR operation of the gate shift clock CPV and first output control signal OE1 supplied from the timing controller 200. Thereafter, the first level shifter 70 generates the first clock signal CKV1 having the same level as the gate ON voltage VON in synchronization with the clock generated by the OR operation and with the gate ON and OFF voltages VON and VOFF supplied from the power source 100. Since the gate shift clock CPV ends after the beginning of the first output control signal OE1, but before the end of the first output control signal OE1, the OR operation of the gate shift clock CPV and first output control signal OE1 results in the first clock signal CKV1 beginning with the start of the gate shift clock CPV and ending with the end of the first output control signal OE1. The first level shifter 70 further includes a logic circuit inverting the first clock signal CKV1 at an output line of the first clock signal CKV1, thereby generating the first inverted clock signal CKVB1 that is an inverted form of the first clock signal CKV1. The first clock signal CKV1 and the first inverted clock signal CKVB1 are supplied to the first gate driving circuit 20. Meanwhile, the first level shifter 70 converts the first gate start pulse STV1 supplied from the timing controller 200 into the first start pulse STVP1 and supplies the first start pulse STVP1 to the first gate driving circuit 20.

Referring to FIG. 5B, the second level shifter 80 includes a logic circuit performing an OR operation of the gate shift clock CPV and the second output control signal OE2, like the first level shifter 70. The second level shifter 80 generates and supplies the second clock signal CKV2, the second inverted clock signal CKVB2, and the second start pulse STVP2 to the second gate driving circuit 30. As shown in FIG. 6B, the second level shifter 80 generates a clock by an OR operation of the gate shift clock CPV and second output control signal OE2 supplied from the timing controller 200. In this case, since the gate shift clock CPV ends after the beginning of the second output control signal OE2, but ends at the same time as the ending of the second output control signal OE2, the OR operation of the gate shift clock CPV and second output control signal OE2 results in the second clock signal CKV2 beginning with the start of the gate shift clock CPV and ending with the end of the gate shift clock CPV and the second output control signal OE2. Thereafter, the second level shifter 80 generates the second clock signal CKV2 having the same level as the gate ON voltage VON in synchronization with the clock generated by the OR operation and with the gate ON and OFF voltages VON and VOFF supplied from the power source 100. The second level shifter 80 further includes a logic circuit for inverting the second clock signal CKV2 at an output line of the second clock signal CKV2, thereby generating the second inverted clock signal CKVB2 that is an inverted form of the second clock signal CKV2. The second clock signal CKV2 and the second inverted clock signal CKVB2 are supplied to the second gate driving circuit 30. Meanwhile, the second level shifter 80 converts the second gate start pulse STV2 supplied from the timing controller 200 into the second start pulse STVP2 and supplies the second start pulse STVP2 to the second gate driving circuit 30.

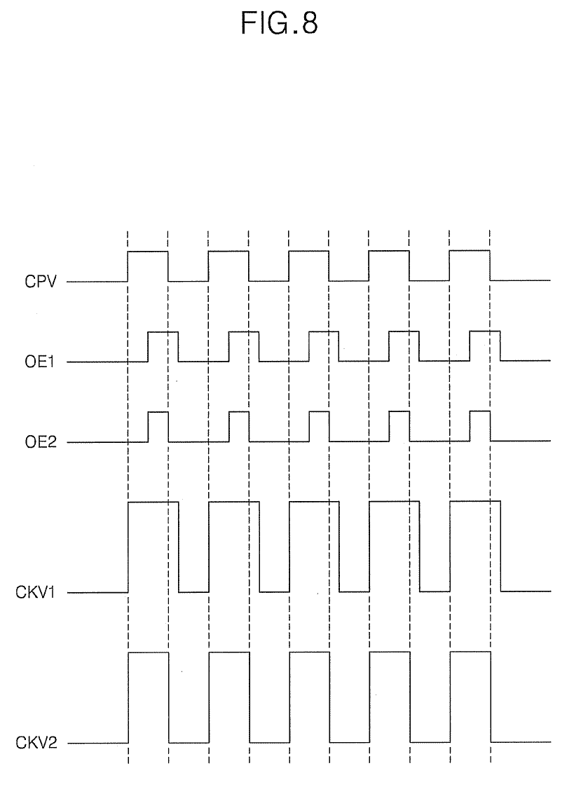

The second output control signal OE2 supplied to the second level shifter 80 has a shorter supply time of a high voltage than the first output control signal OE1. Therefore, the second clock signal CKV2 has a shorter supplying time of a high voltage than the first clock signal CKV1, as shown in FIG. 8.

The first and second level shifters 70 and 80 may be mounted on the data PCB 40 as shown in FIG. 4. In such an arrangement, the clock signals generated from the first and second level shifters 70 and 80 are supplied to the first and second gate driving circuits 20 and 30 via signal lines formed in the data TCP 50.

The first gate driving circuit 20 generates a gate driving signal driving the gate lines GL1 to GLi by using the first clock signal CKV1, first inverted clock signal CKVB1, and first start pulse STVP1 supplied from the first level shifter 70 and by a direct current (“DC”) voltage VSS supplied from the power source 100. To this end, the first gate driving circuit 20 includes a plurality of shift registers connected in series to each other.

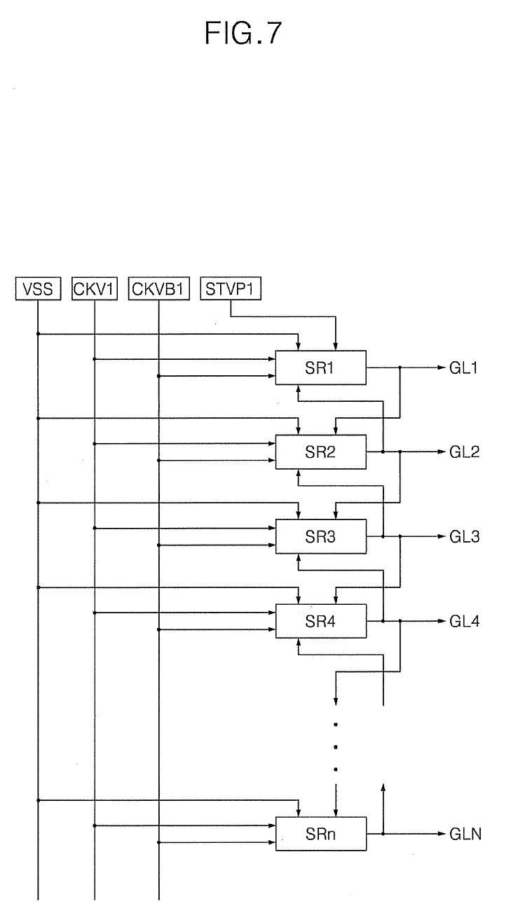

Referring to FIG. 7, shift registers SR1 to SRn formed in the first gate driving circuit 20 selectively output the first clock signal CKV1 and the first inverted clock signal CKVB1 input from the first level shifter 70. The first clock signal CKV1 or the first inverted clock signal CKVB1 output from the shift registers SR1 to SRn is a gate driving signal including the gate ON and OFF voltages VON and VOFF. The gate driving signals are supplied to the gate lines. In addition, the shift registers SR1 to SRn include signal lines for supplying the gate driving signals generated from the previous shift register SRn−1 and the next shift register SRn+1 to the current shift register SRn.

The first shift register SR1 outputs either the first clock signal CKV1 or the first inverted clock signal CKVB1 by the first clock signal CKV1, first inverted clock signal CKVB1, and first start pulse STVP1 input from the first level shifter 70 and by the gate ON or OFF voltage VON or VOFF supplied through the signal line for supplying the gate driving signal of the next shift register. The first start pulse STVP1 is supplied to the first shift register SR1 and drives the first gate line GL1. Namely, the first shift register SR1 supplies the gate ON voltage VON to the first gate line GL1 through the first start pulse STVP1 and the first clock signal CKV1. After the gate ON voltage VON is supplied, the first shift register SR1 outputs the first inverted clock signal CKVB1 and supplies the gate OFF voltage VOFF to the first gate line GL1. The second shift register SR2 outputs the first inverted clock signal CKVB1 while the gate ON voltage VON is supplied to the first gate line GL1. When the gate OFF voltage VOFF is supplied to the first gate line GL1, the second shift register SR2 outputs the first clock signal CKV1 in synchronization with the gate ON voltage VON and supplies the gate ON voltage VON to the second gate line GL2. The other shift registers connected in series to the second shift register SR2 sequentially supply the gate ON voltage VON as described above.

The second gate driving circuit 30 sequentially supplies a precharge voltage VF to the gate lines GL by the second clock signal CKV2, second inverted clock signal CKVB2, and second start pulse STVP2 supplied from the second level shifter 80 and by the DC voltage VSS supplied from the power source 100. To this end, the second gate driving circuit 30 includes a plurality of shift registers connected in series to each other, like the shift registers SR1 to SRn formed in the first gate driving circuit 20 shown in FIG. 7. The shift registers formed in the second gate driving circuit 30 are formed in the same form as the shift registers SR1 to SRn of the first gate driving circuit 20. The shift registers formed in the second gate driving circuit 30 select any one of the second clock signal CKV2 and the second inverted clock signal CKVB2 and supply the precharge voltage VF to the corresponding gate line. In this case, the second gate driving circuit 30 supplies the precharge voltage VF to the (N+4n)^{th} gate line GLN+4n while the gate ON voltage VON is supplied to the N^{th} gate line GLN in the first gate driving circuit 20. A supplying time of the precharge voltage VF is shorter than that of the gate ON voltage VON

As shown in FIG. 8, since the supply time of a high voltage of the second output control signal OE2 is shorter than that of the first output control signal OE1, a supplying time of a high voltage of the second clock signal CKV2 becomes shorter than that of the first clock signal CKV1. That is, the first output control signal OE1 ends later than the second output control signal OE2 so that the OR operation of the gate shift clock CPV and the first output control signal OE1 results in a first clock signal CKV1 that has a longer duration than the second clock signal CKV2 resulting from the OR operation of the gate shift clock CPV and the second output control signal OE2. Since the first clock signal CKV1 supplies the gate ON voltage VON and the second clock signal CKV2 supplies the precharge voltage VF, a supplying time of the precharge voltage VF is shorter than that of the gate ON voltage VON. Thus, abnormal driving may be prevented by precharging the gate line by the precharge voltage VF.

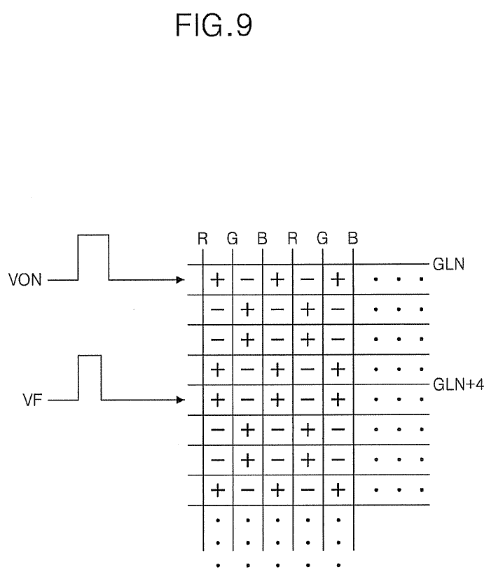

FIG. 9 is a plan view illustrating an exemplary embodiment of a driving method of the exemplary LCD panel by a vertical 2-dot inversion driving method in accordance with the present invention.

In the vertical 2-dot inversion driving method, the LCD panel is driven in such a manner that the polarity of each subpixel is inverted on a 2-dot basis in the vertical or column direction and on a one dot basis in the horizontal or row direction. Therefore, a first horizontal line having the opposite polarity to a previous line and a second horizontal line having the same polarity as the previous line are alternately formed in the LCD panel. In other words, a pixel area formed in the LCD panel 10 has the same polarity variation every fourth gate line as shown in FIG. 9. For example, the first gate line GL1 would have the same polarity variation as the fifth, ninth, thirteenth gate lines GL5, GL9, GL13, etc. To improve a response speed of liquid crystals, the first gate driving circuit 20 supplies the gate ON voltage VON to the first gate line GL1 and at the same time the second gate driving circuit 30 supplies the precharge voltage VF to the fifth gate line GL5. Then pixels connected to the fifth gate line GL5 are precharged by the precharge voltage VF while pixels connected to the first gate line GL1 are driven. When the gate ON voltage VON is supplied to the precharged fifth gate line GL5, data is charged to a pixel electrode. At this time, since the liquid crystals of a corresponding pixel have been previously driven, actual data is provided to more rapidly drive the liquid crystals.

Since a corresponding pixel area has been precharged by the precharge voltage VF supplied previously to each pixel area, it is unnecessary to increase a storage voltage supplied by the storage capacitor in each pixel. When the LCD panel 10 is driven as described above, an electrode area of a storage capacitor formed in a pixel area may be reduced. Accordingly, an aperture ratio may be improved by reducing the electrode area of the storage capacitor.

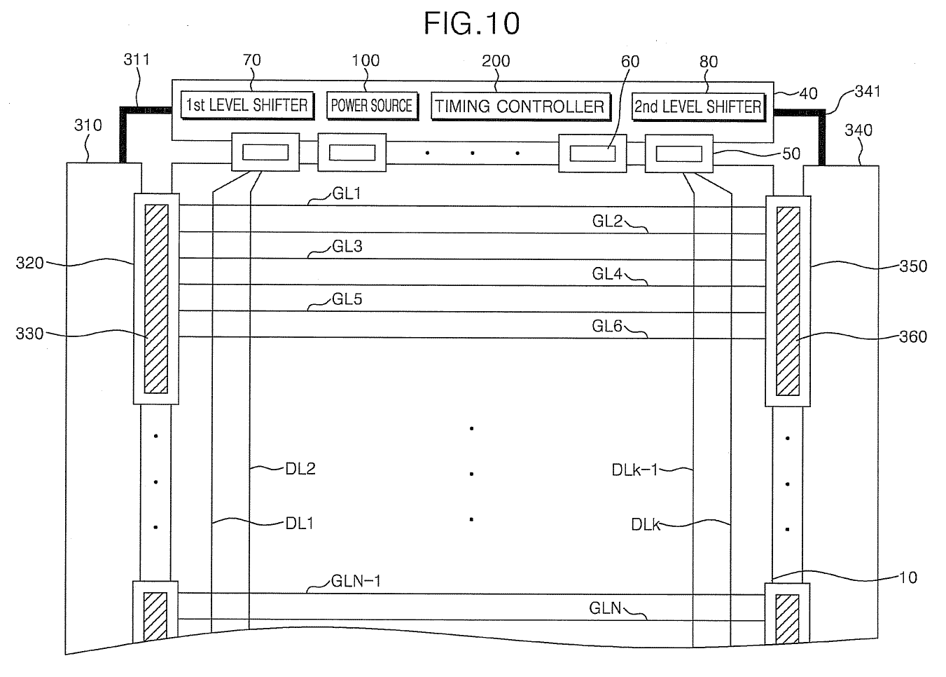

FIG. 10 is a plan view schematically illustrating another exemplary embodiment an exemplary LCD device in accordance with the present invention. In the LCD device of FIG. 10, first and second gate driving circuits 330 and 360 are not integrated in the TFT substrate of the LCD panel 10, but are instead mounted on the first and second gate TCPs 320 and 350 respectively, unlike the LCD device of FIG. 4. The first and second gate driving circuits 330 and 360 are connected to the LCD panel 10 and to first and second gate PCBs 310 and 340, respectively. The first and second level shifters 70 and 80 may be mounted in the data PCB 40, or mounted in the first and second gate PCBs 310 and 340, respectively.

Referring to FIG. 10, the LCD device according to the exemplary embodiment of the present invention includes the LCD panel 10 in which a plurality of gate lines GL1 to GLi and a plurality of data lines DL1 to DLk are formed. The first gate PCB 310 supplies the precharge voltage VF to the (N+4n)^{th} gate line GLN+4n when the gate ON voltage VON is supplied to the N^{th} gate line GLN. The first gate TCP 320 has a first side attached to the first gate PCB 310 and has a second side attached to a first side of the LCD panel 10. The first gate driving circuit 330 is mounted on the first gate TCP 320. The second gate TCP 350 has a first side connected to the second gate PCB 340 and has a second side attached to a second side of the LCD panel 10. The second gate driving circuit 360 is mounted on the second gate TCP 350.

In such an arrangement, the first gate PCB 310 receives signals through a first connection film 311 connected to the data PCB 40. The first gate PCB 310 receives the power signal, first clock signal CKV1, first inverted clock signal CKVB1, and first start pulse STVP1 from the power source 100 and the first level shifter 70 mounted on the data PCB 40, and supplies the signals to the first gate driving circuit 330 mounted on the first gate TCP 320.

The first gate driving circuit 330 selectively outputs the gate ON and OFF voltages VON and VOFF by the first clock signal CKV1, first inverted clock signal CKVB1, and the first start pulse STVP1 supplied from the first gate PCB 310, and sequentially supplies the selected signal to the gate lines of the LCD panel 10 connected o the first gate TCP 320.

The second gate PCB 340 receives signals through a second connection film 341 connected to the data PCB 40. Like the first gate PCB 310, the second gate PCB 340 receives the power signal, second clock signal CKV2, second inverted clock signal CKVB2, and second start pulse STVP2 from the power source 100 and second level shifter 80, and supplies the signals to the second gate driving circuit 360 mounted on the second gate TCP 350.

The second gate driving circuit 360 selectively outputs the precharge voltage VF and the gate OFF voltage VOFF by the second clock signal CKV2, second inverted clock signal CKVB2, and second start pulse STVP2 supplied from the second gate PCB 340, and sequentially supplies the selected signal to the gate lines of the LCD panel 10 connected to the second gate TCP 350.

The second gate driving circuit 360 supplies the precharge voltage VF to the (N+4n)^{th} gate line GLN+4n while the first gate driving circuit 330 supplies the gate ON voltage VON to the N^{th} gate line GLN. Then subpixels connected to the (N+4n)^{th} gate line GLN+4n are precharged. For example, when the LCD panel 10 is driven by the vertical 2-dot inversion driving method shown in FIG. 9, the second gate driving circuit 360 supplies the precharge voltage VF to the fifth gate line GL5 while the first gate driving circuit 330 supplies the gate ON voltage to the first gate line GL1. The first gate driving circuit 330 sequentially supplies the gate ON voltage VON to the plurality of gate lines GL1 to GLi, and the second gate driving circuit 360 sequentially supplies the precharge voltage VF to the plurality of gate lines GL1 to GLi.

In an alternative embodiment, the first and second level shifters 70 and 80 may be mounted in the first and second gate PCBs 310 and 340, respectively, instead of within the data PCB 40. Namely, the timing controller 200 and the power source 100 may be mounted on the data PCB 40 to supply the control signal and the power signal to the first and second level shifters 70 and 80. The first and second level shifters 70 and 80 may generate and supply to corresponding gate driving circuits 330, 360 the first and second clock signals CKV1 and CKV2, the first and second inverted clock signals CKVB1 and CKVB2, and the first and second start pulses STVP1 and STVP2.

In other alternative embodiments, the first and second gate driving circuits 330 and 360 may be directly mounted on the LCD panel 10 in a chip-on-glass (“COG”) form. In addition, the first and second gate driving circuits 330 and 360 may include the first and second level shifters 70 and 80 so that they do not use additional level shifters.

As described above, the LCD device of the present invention includes the first and second gate driving circuits. When the gate ON voltage is supplied to the N^{th} gate line, pixels connected to the (N+4n)^{th} gate line are precharged by supplying the precharge voltage to the (N+4n)^{th} gate line. Namely, a response time can be shortened when the gate ON voltage is supplied to a corresponding pixel by previously driving the liquid crystals.

Moreover, since the pixel is precharged, an area of the storage electrode for maintaining a charge rate can be reduced and an aperture ratio can be increased as much as the reduced area of the storage electrode.

Furthermore, since a supply time of a precharge voltage is determined through a gate output control signal without generating an additional signal from the timing controller in order to drive the second gate driving circuit, the timing controller and the power source do not increase current consumption, thereby increasing the efficiency of power use.

Although exemplary embodiments of the present invention have been described, it is understood that the present invention should not be limited to these exemplary embodiments but various changes and modifications can be made by one of ordinary skill in the art within the sprit and scope of the present invention as hereinafter claimed.

What is claimed is:

1. A liquid crystal display device, comprising:
a liquid crystal display panel displaying images; and
first and second gate driving circuits connected to first and second sides of each of a plurality of gate lines formed in the liquid crystal display panel;
wherein when the first gate driving circuit supplies a gate ON voltage to an N^{th} gate line, where N is a natural number, the second gate driving circuit supplies a gate precharge voltage to an (N+4n)^{th} gate line, where n is a natural number.

2. The liquid crystal display device of claim 1, wherein the first and second gate driving circuits are integrated in the liquid crystal display panel.

3. The liquid crystal display device of claim 2, further comprising:
a first level shifter generating a first clock signal, a first inverted clock signal, and a first start pulse and supplying the first clock signal, the first inverted clock signal, and the first start pulse to the first gate driving circuit; and
a second level shifter generating a second clock signal, a second inverted clock signal, and a second start pulse and supplying the second clock signal, the second inverted clock signal, and the second start pulse to the second gate driving circuit.

4. The liquid crystal display device of claim 3, further comprising:
a power source supplying the gate ON voltage and a gate OFF voltage to the first and second level shifters; and
a timing controller supplying to the first level shifter a first gate start signal selecting a first gate line, a gate shift clock selecting a next gate line, and a first output control signal controlling an output of the first clock signal, and the timing controller supplying to the second level shifter a second gate start signal selecting the first gate line, the gate shift clock selecting the next gate line, and a second output control signal controlling an output of the second clock signal.

5. The liquid crystal display device of claim 4, wherein the first level shifter includes a logic circuit generating a clock by an OR operation of the gate shift clock and the first output control signal and the second level shifter includes a logic circuit generating a clock by an OR operation of the gate shift clock and the second output control signal.

6. The liquid crystal display device of claim 5, further comprising:
a data driving circuit driving data lines formed in the liquid crystal display panel;
a data tape carrier package on which the data driving circuit is mounted; and
a data printed circuit board on which the power source, the timing controller, and the first and second level shifters are mounted, the data printed circuit board connecting with the data tape carrier package.

7. The liquid crystal display device of claim 5, wherein a supply time of a high voltage of the second output control signal is same as or shorter than a supply time of a high voltage of the first output control signal.

8. The liquid crystal display device of claim 7, wherein the first gate driving circuit includes a first shift register outputting the first clock signal as the gate ON voltage and outputting the first inverted clock signal as the gate OFF voltage and the second gate driving circuit includes a second shift register outputting the second clock signal as the gate precharge voltage and outputting the second inverted clock signal as the gate OFF voltage.

9. The liquid crystal display device of claim 8, wherein a supplying time of the precharge voltage is same as or shorter than a supplying time of the gate ON voltage.

10. The liquid crystal display device of claim 1, wherein the first and second gate driving circuits are mounted in the liquid crystal display panel in a chip-on-glass form.

11. The liquid crystal display device of claim 1, further comprising:
first and second gate tape carrier packages on which the first and second gate driving circuits are mounted respectively and the first and second gate tape carrier packages are connected to the liquid crystal display panel; and
first and second gate printed circuit boards connected respectively to the first and second gate tape carrier packages, supplying signals to the first and second gate driving circuits.

12. The liquid crystal display device of one of claims 1, wherein the liquid crystal display panel is driven by a vertical n-dot inversion method, where n is a natural number, in which a polarity of a subpixel is inverted on an n-dot basis in a vertical direction and inverted on one dot basis in a horizontal direction.

13. A method of driving a liquid crystal display device, the method comprising:
supplying a gate ON voltage to an N^{th} gate line, where N is a natural number, by a first gate driving circuit; and
supplying a precharge voltage to an (N+4n)^{th} gate line, where n is a natural number, by a second gate driving circuit while the gate ON voltage is supplied to the N^{th} gate line.

14. The method of claim 13, further comprising:
generating a first clock signal, a first inverted clock signal, and a first start pulse by a first level shifter and supplying the first clock signal, the first inverted clock signal, and the first start pulse to the first gate driving circuit; and
generating a second clock signal, a second inverted clock signal, and a second start pulse by a second level shifter and supplying the second clock signal, the first inverted clock signal, and the first start pulse to the second gate driving circuit.

15. The method of claim 14, further comprising:
supplying a first gate start signal, a gate shift clock, and a first output control signal to the first level shifter and supplying a second gate start signal, the gate shift clock, and a second output control signal to the second level shifter by a timing controller and supplying the gate ON and OFF voltages to the first and second level shifters by a power source.

16. The method of claim 15, further comprising:
generating the first clock signal by an OR operation of the gate shift clock and the first output control signal and generating the first inverted clock signal that is an inverted signal of the first clock signal by the first level shifter, and supplying the first clock signal and the first inverted clock signal to the first gate driving circuit; and
generating the second clock signal by an OR operation of the gate shift clock and the second output control signal and generating the second inverted clock signal that is an inverted signal of the second clock signal by the second level shifter, and supplying the second clock signal and the second inverted clock signal to the second gate driving circuit.

17. The method of claim 16, further comprising:
outputting the first clock signal as the gate ON voltage by the first gate driving circuit when the N^{th} gate line is driven, and outputting the second clock signal as the precharge voltage to the (N+4n)^{th} gate line by the second gate driving circuit.

18. The method of claim 13, wherein a supplying time of the precharge voltage to the (N+4n)^{th} gate line is same as or shorter than a supplying time of the gate ON voltage to the N^{th} gate line.

19. A liquid crystal display device, comprising:
a liquid crystal display panel displaying images; and
first and second gate driving circuits connected to first and second sides of each of a plurality of gate lines formed in the liquid crystal display panel;
wherein the second gate driving circuit supplies a gate precharge voltage to a subsequent gate line among the plurality of gate lines when the first gate driving circuit supplies a gate ON voltage to a previous gate line among the plurality of gate lines.

20. The liquid crystal display of claim 19, further comprising a matrix of pixels within the liquid crystal display panel, wherein pixels connected to the subsequent gate line are precharged by the second gate driving circuit when the first gate driving circuit supplies a gate ON voltage to the subsequent gate line.
